(19) United States
(12) Patent Application Publication
(10) Pub. No.: US 2022/0029349 A1
(43) Pub. Date: Jan. 27, 2022

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki KOBAYASHI, Mie (JP); Hajime KAWASE, Mie (JP); Masaaki TABATA, Mie (JP); Yasuo OMORI, Mie (JP); Teruo HARA, Mie (JP); Hajime MATSUI, Mie (JP)

(21) Appl. No.: 17/296,407

(22) PCT Filed: Nov. 13, 2019
(86) PCT No.: PCT/JP2019/044531

§ 371 Date: May 24, 2021

(51) Int. Cl. H01R 13/52; H01R 13/502; H01R 4/18

(52) U.S. Cl. CPC H01R 13/5208; H01R 4/18; H01R 13/5202; H01R 13/502

(57) ABSTRACT

It is aimed to prevent the damage of sealing holes. A connector includes terminal fittings (30) to be connected to front end parts of wires (39), a housing (10), and a one-piece rubber plug (40) mounted in a rear end part of the housing (10). Accommodation chambers (15) for allowing insertion of the terminal fittings (30) from front of the housing (10) are formed in the housing (10). The one-piece rubber plug (40) includes sealing holes (41). The wires (39) not connected to the terminal fittings (30) are passable through the accommodation chambers (15) and the sealing holes (41).

### TECHNICAL FIELD

The present disclosure relates to a connector.

### BACKGROUND

Patent Document 1 discloses a connector including a housing formed with a plurality of cavities inside, a one-piece rubber plug mounted in a rear end part of the housing and a rear holder for restricting the separation of the one-piece rubber plug by being mounted in the housing. Terminal fittings connected to front end parts of wires successively pass through holes of the rear holder and sealing holes of the one-piece rubber plug from behind the housing to be accommodated into the cavities. With the terminal fittings accommodated in the cavities, the sealing holes are resiliently held in close contact with the outer peripheries of the wires, thereby preventing water entrance into the cavities from behind the housing.

Further, in the connector of Patent Document 1, resiliently deformable locking lances serving as means for retaining the terminal fittings are formed in the cavities. In the process of inserting the terminal fitting into the cavity, the locking lance is resiliently deformed by interference with the terminal fitting. If the terminal fitting is inserted to a proper position, the locking lance resiliently returns to lock the terminal fitting, whereby the terminal fitting is held retained.

### PRIOR ART DOCUMENT

### Patent Document

Patent Document 1: JP 2013-235747 A

### SUMMARY OF THE INVENTION

### Problems to be Solved

In the above connector, there is a concern that the inner periphery of the sealing hole is damaged by the terminal fitting when the terminal fitting passes through the sealing hole. Further, if the wire vibrates outside and behind the housing, a part of the wire held in close contact with the inner periphery of the sealing hole also vibrates. Thus, there is a concern that a close contact state between the outer periphery of the wire and the inner periphery of the sealing hole becomes unstable and sealing performance is reduced.

Further, in mounting the terminal fitting into the connector housing, the terminal fitting is pushed into the cavity by pinching the wire fixed to a rear end part of the terminal fitting. In the process of inserting the terminal fitting, if the locking lance is resiliently deflected, an insertion resistance due to a resilient restoring force of the locking lance acts on the terminal fitting. Thus, there is a concern that the wire is buckled due to the insertion resistance of the locking lance and a terminal fitting mounting operation is hindered.

A connector of a first aspect of the disclosure was completed on the basis of the above situation and aims to prevent the damage of sealing holes. A connector of a second aspect of the disclosure was completed on the basis of the above situation and aims to improve workability when terminal fittings are mounted.

### Means to Solve the Problem

A connector of a first aspect of the disclosure includes terminal fittings to be connected to front end parts of wires, a housing, and a one-piece rubber plug mounted in a rear end part of the housing, wherein accommodation chambers for allowing insertion of the terminal fittings from front of the housing are formed in the housing, the one-piece rubber plug includes sealing holes, and the wires not connected to the terminal fittings are passable through the accommodation chambers and the sealing holes.

A connector of a second aspect of the disclosure includes terminal fittings to be connected to front end parts of wires, a housing, and a rear member mounted in a rear end part of the housing, wherein the terminal fitting includes a terminal body portion having a maximum external dimension larger than an outer diameter of the wire, accommodation chambers for allowing insertion of the terminal fittings from front of the housing are formed in the housing, the wires being passable through the accommodation chambers, the rear member is formed with wire through holes, the wires not connected to the terminal fittings are passable through the wire through holes, and the terminal body portions are not passable through the wire through holes.

### Effect of the Invention

According to the present disclosure, it is possible to prevent the damage of sealing holes. According to the second aspect of the disclosure, it is possible to improve workability when terminal fittings are mounted.

### BRIEF DESCRIPTION OF THE DRAWINGS

FIG. 1 is a perspective view of a connector in one embodiment.

FIG. 2 is a front view of the connector.

FIG. 3 is a section along X-X of FIG. 2.

FIG. 4 is a section along Y-Y of FIG. 2.

FIG. 5 is a section along Z-Z of FIG. 2.

FIG. 6 is a perspective view showing a disassembled state of a housing, a sealing ring, a one-piece rubber plug and a rear member.

FIG. 7 is a perspective view showing a state where a terminal fitting is connected to a wire.

FIG. 8 is a perspective view showing a state where wires not connected to the terminal fittings are inserted through the housing.

FIG. 9 is a perspective view showing a state where the terminal fittings are connected to the wires passed through the housing.

FIG. 10 is a perspective view showing a state where the terminal fittings connected to the wires are accommodated in the housing.

### DETAILED DESCRIPTION TO EXECUTE THE INVENTION

[Description of Embodiments of First and Second Aspects of Disclosure]

First, embodiments of the first aspect of the disclosure are listed and described. (1) A connector of the first aspect of the disclosure includes terminal fittings to be connected to front end parts of wires, a housing, and a one-piece rubber plug mounted in a rear end part of the housing, wherein accommodation chambers for allowing insertion of the terminal fittings from front of the housing are formed in the housing, the one-piece rubber plug includes sealing holes, and wires not connected to the terminal fittings are passable through the accommodation chambers and the sealing holes.

According to the configuration of the first aspect of the disclosure, if the wire is passed through the accommodation chamber and the sealing hole, the terminal fitting is connected to the front end part of the wire in front of the housing and the wire is pulled rearward after the terminal fitting is connected, the terminal fitting can be accommodated into the accommodation chamber. Since the terminal fitting needs not be passed through the sealing hole, the damage of the sealing hole can be prevented.

(2) Preferably, the terminal fitting includes a terminal body portion having a maximum external dimension larger than an outer diameter of the wire, the accommodation chamber includes a narrow portion, the wire is passable through the narrow portion, and the terminal body portion is not passable through the narrow portion. According to this configuration, even if vibration is transferred to the terminal fitting, the rattling of the wire in the accommodation chamber is suppressed by the narrow portion. In this way, the deformation of the sealing hole is suppressed, wherefore high sealing performance is ensured.

(3) Preferably, the narrow portion communicates with a front end of the sealing hole and is disposed concentrically with respect to the sealing hole. If the narrow portion is adjacent to the sealing hole in such a positional relationship as to be eccentric with respect to the sealing hole, there is a concern that the sealing hole is improperly deformed and sealing performance is reduced. However, according to the above configuration, since the sealing hole and the narrow portion are concentric, sealing performance is high.

(4) Preferably, the accommodation chamber includes an accommodation recess open in a front end surface of the housing, the accommodation recess is capable of accommodating the terminal body portion, and the accommodation recess is formed with a retaining portion, the terminal body portion being able to come into contact with the retaining portion from front. According to this configuration, a rearward movement of the terminal fitting can be restricted by bringing the terminal body portion into contact with the retaining portion.

(5) Preferably, the accommodation recess communicates with a front end of the narrow portion and is disposed eccentrically with respect to the narrow portion. According to this configuration, since the accommodation recess and the narrow portion are eccentrically disposed, a wide area of the retaining portion can be secured and a function of retaining the terminal fitting can be improved.

(6) Preferably, the terminal fitting includes a terminal body portion having a maximum external dimension larger than an outer diameter of the wire, a rear member is provided behind the one-piece rubber plug, and the rear member includes wire through holes enabling the passage of the wires therethrough and disabling the passage of the terminal body portions therethrough. According to this configuration, even if the wire vibrates behind the rear member, the rattling of the wire is suppressed by the wire through hole. In this way, the deformation of the sealing hole is suppressed, wherefore high sealing performance is ensured.

Next, embodiments of the second aspect of the disclosure are listed and described.

(7) A connector of the second aspect of the disclosure includes terminal fittings to be connected to front end parts of wires, a housing, and a rear member mounted in a rear end part of the housing, wherein the terminal fitting includes a terminal body portion having a maximum external dimension larger than an outer diameter of the wire, accommodation chambers for allowing insertion of the terminal fittings from front of the housing are formed in the housing, the wires being passable through the accommodation chambers, the rear member is formed with wire through holes, the wires not connected to the terminal fittings are passable through the wire through holes, and the terminal body portions are not passable through the wire through holes.

According to this configuration, if the terminal fitting is connected to the wire passed through the accommodation chamber and the wire is pulled rearward in that state, the terminal body portion is accommodated into the accommodation chamber and the terminal fitting is mounted in the housing. In mounting the terminal fitting, it is sufficient to pull the wire. Thus, the buckling of the wire can be prevented. Further, since the wire through hole has a smaller diameter than the accommodation chamber where the terminal body portion is to be accommodated, the rattling of the wire in the accommodation chamber is suppressed by being guided by the wire through hole. In this way, an operation of inserting the terminal fitting into the accommodation chamber is smoothly performed. Therefore, workability is good when the terminal fitting is mounted into the housing.

(8) Preferably, a one-piece rubber plug including sealing holes is mounted into a rear end part of the housing, the rear member is arranged behind the one-piece rubber plug, and the wires not connected to the terminal fittings are passable through the sealing holes. According to this configuration, if the wire is passed through the accommodation chamber and the sealing hole, the terminal fitting is connected to the front end part of the wire in front of the housing and the wire is pulled rearward after the terminal fitting is connected, the terminal fitting can be accommodated into the accommodation chamber. Since the terminal fitting needs not be passed through the sealing hole, the damage of the sealing hole can be prevented.

(9) Preferably, the accommodation chamber includes a narrow portion enabling the passage of the wire therethrough and disabling the passage of the terminal body portion therethrough. According to this configuration, even if vibration is transferred to the terminal fitting, the rattling of the wire in the accommodation chamber is suppressed by the narrow portion. In this way, the deformation of the sealing hole is suppressed and high sealing performance is ensured.

(10) Preferably, the narrow portion communicates with a front end of the sealing hole and is disposed concentrically with respect to the sealing hole. If the narrow portion is adjacent to the sealing hole in such a positional relationship as to be eccentric with respect to the sealing hole, there is a concern that the sealing hole is improperly deformed and sealing performance is reduced. However, since the sealing hole and the narrow portion are concentric according to the above configuration, sealing performance is high.

(11) Preferably, the accommodation chamber includes an accommodation recess open in a front end surface of the housing and capable of accommodating the terminal body portion, and the accommodation recess is formed with a retaining portion, the terminal body portion being able to come into contact with the retaining portion from front. According to this configuration, a rearward movement of the terminal fitting can be restricted by bringing the terminal body portion into contact with the retaining portion.

(12) Preferably, the accommodation recess communicates with a front end of the narrow portion and is disposed eccentrically with respect to the narrow portion. According to this configuration, since the accommodation recess and the narrow portion are eccentrically disposed, a wide area of the retaining portion can be secured and a function of retaining the terminal fitting can be improved.

### Details of Embodiment of Present Disclosure

[Embodiment]

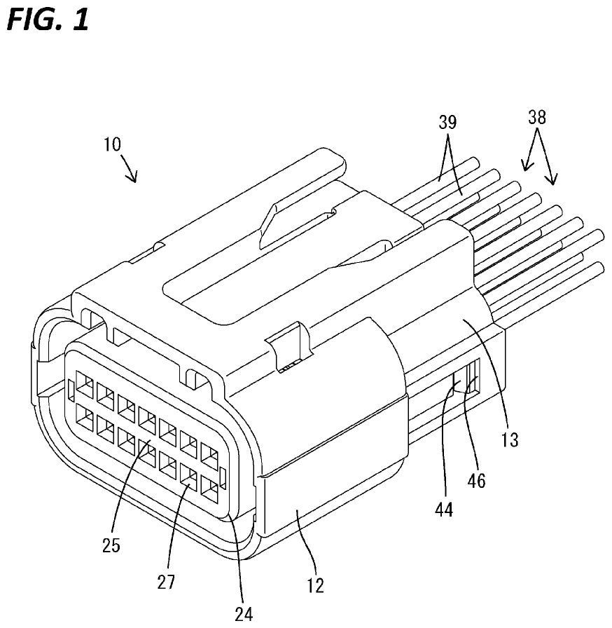

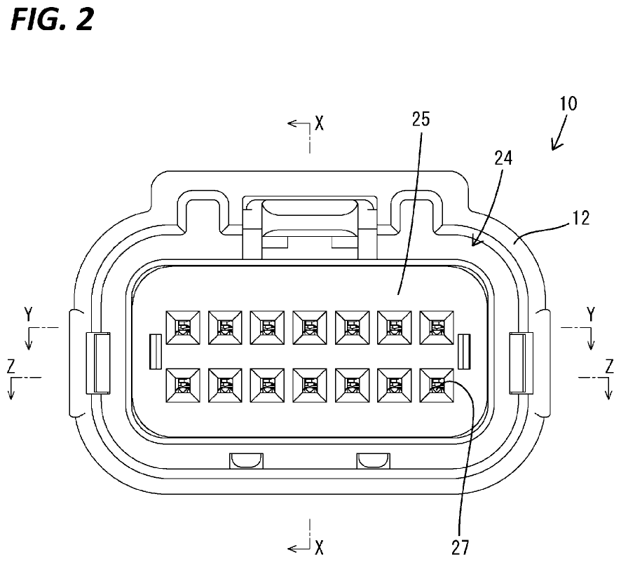

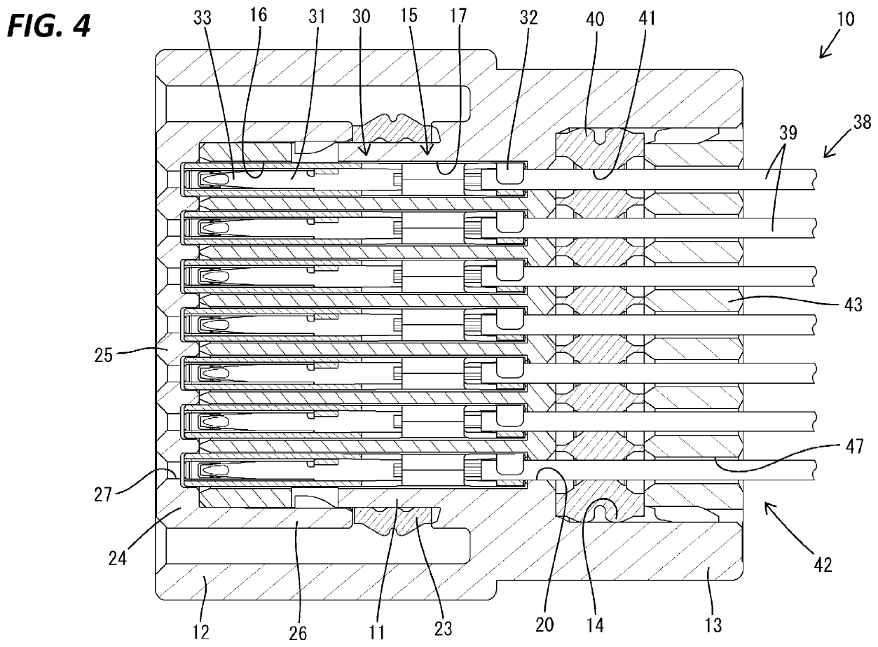

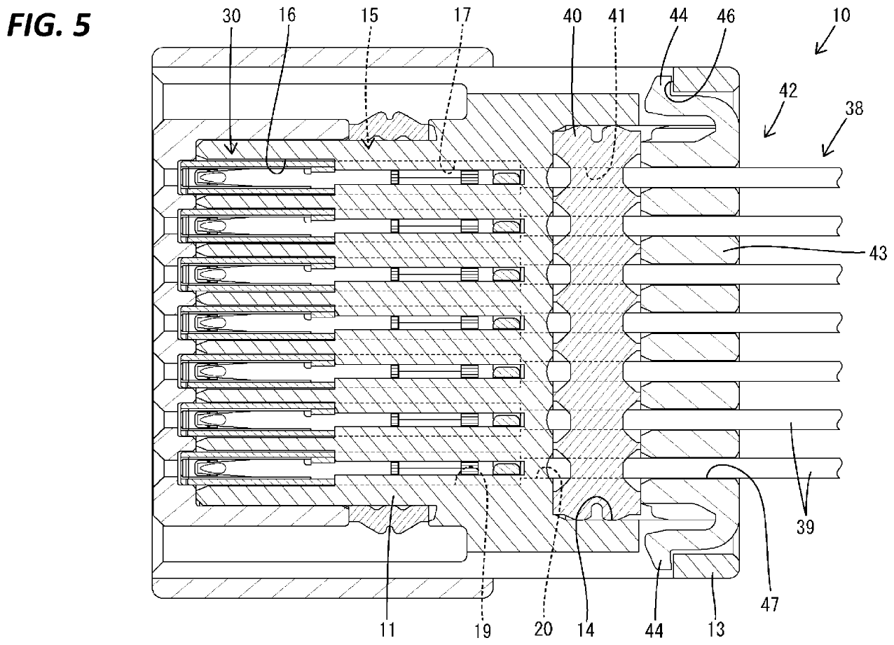

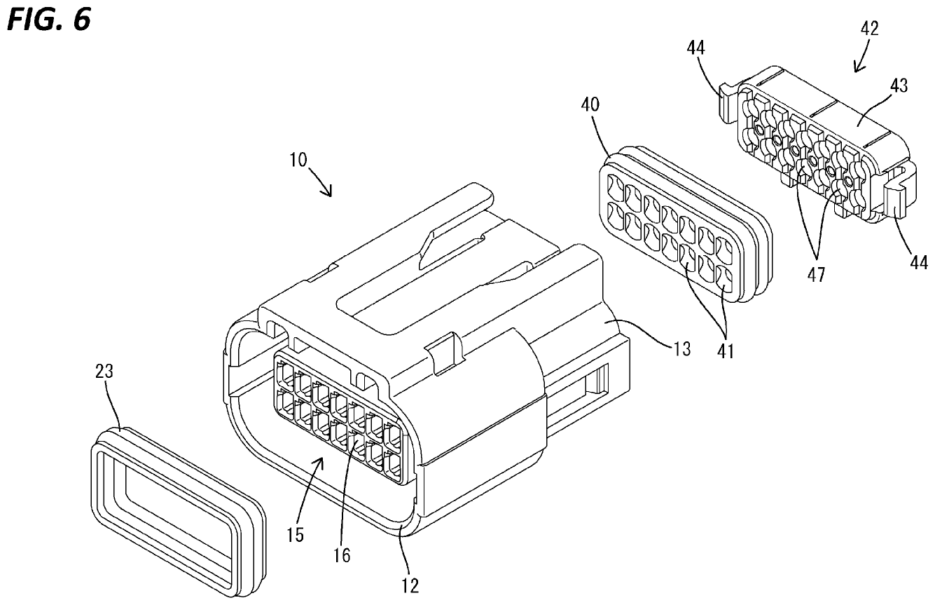

A specific embodiment of the present disclosure is described with reference to FIGS. 1 to 10. Note that the present invention is not limited to these illustrations and is intended to be represented by claims and include all changes in the scope of claims and in the meaning and scope of equivalents. In the following description, a left side in FIGS. 1 and 3 to 10 is defined as a front side concerning a front-rear direction. Upper and lower sides shown in FIGS. 1 to 3 and 6 to 10 are directly defined as upper and lower sides concerning a vertical direction.

A connector of this embodiment includes one housing 10, one sealing ring 23, one front member 24, a plurality of terminal fittings 30, one one-piece rubber plug 40 and one rear member 42. The connector exhibits a waterproof function by the sealing ring 23 and the one-piece rubber plug 40.

The housing 10 is a single component made of synthetic resin and including a terminal accommodating portion 11, a tubular fitting portion 12 and a tubular accommodating portion 13. The terminal accommodating portion 11 is in the form of a block as a whole. The tubular fitting portion 12 surrounds the terminal accommodating portion 11 except a rear end part. The tubular accommodating portion 13 is in the form of a rectangular tube extending rearward from the outer peripheral edge of the rear end of the terminal accommodating portion 11. An internal space of the tubular accommodating portion 13 serves as an accommodation space 14 open in the rear end surface of the housing 10. The rear end surface of the terminal accommodating portion 11 is facing the accommodation space 14.

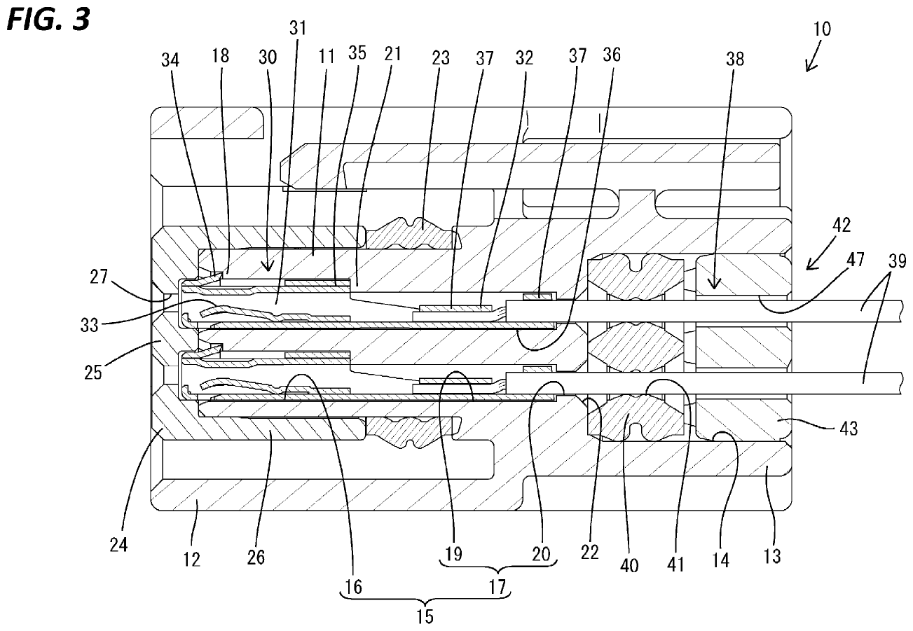

As shown in FIG. 3, the terminal accommodating portion 11 is formed with a plurality of accommodation chambers 15 penetrating through the terminal accommodating portion 11 (housing 10) in the front-rear direction. Each accommodation chamber 15 has an elongated shape in the front-rear direction as a whole and composed of an accommodation recess 16 open in the front end surface of the terminal accommodating portion 11 (housing 10) and a narrow portion 17 communicating with the rear end of the accommodation recess 16. A cross-sectional shape (front view shape) of the accommodation recess 16 perpendicular to a penetration direction (front-rear direction) of the accommodation chamber 15 is substantially rectangular. A first retaining portion 18 (retaining portion as claimed) is formed on a front end part of an upper surface wall part, out of the inner wall surface of the accommodation recess 16. The first retaining portion 18 is arranged in the accommodation chamber 15.

The narrow portion 17 is composed of a low-height portion 19 having a smaller height than the accommodation recess 16 and a wire holding portion 20 communicating with the rear end of the low-height portion 19. The low-height portion 19 communicates with the rear end of the accommodation recess 16. A cross-sectional shape of the low-height portion 19 perpendicular to the penetration direction of the accommodation recess 15 is substantially rectangular. A width of the low-height portion 19 is equal to that of the accommodation recess 16, and the low-height portion 19 is arranged concentrically with the accommodation recess 16 in a width direction (lateral direction) of the accommodation recess 16. The low-height portion 19 is arranged at a position eccentric downward from the accommodation recess 16 in a height direction (vertical direction).

A lower surface wall part constituting the inner wall surface of the low-height portion 19 is continuous and flush with a lower surface wall part constituting the inner wall surface of the accommodation recess 16. Accordingly, an upper surface wall part constituting the inner wall surface of the low-height portion 19 is lowered from the lower surface wall part of the accommodation recess 16 in a stepped manner. Due to a height difference between the upper surface wall part of the accommodation recess 16 and the upper surface wall part of the low-height portion 19, a second retaining portion 21 (retaining portion as claimed) is formed on the rear end surface of the accommodation recess 16. The second retaining portion 21 is arranged in the accommodation chamber 15, similarly to the first retaining portion 18.

The rear end of the wire holding portion 20 is open in the rear end surface of the terminal accommodating portion 11 (open to the inside of the accommodation space 14). A width of the wire holding portion 20 is smaller than that of the low-height portion 19, and a height thereof is smaller than that of the low-height portion 19. A guide surface 22 gradually enlarged in diameter toward a rear side is formed on the inner periphery of a rear end part of the wire holding portion 20. The rear end of the guide surface 22 is facing the inside of the accommodation space 14. The guide surface 22 guides a wire 39 into the wire holding portion 20 by causing a front end part of the wire 39 to slide in contact therewith.

The sealing ring 23 is mounted on the outer periphery of the terminal accommodating portion 11 from front of the housing 10. The front member 24 is a single component made of synthetic resin and including a front wall portion 25 and an outer fitting portion 26 in the form of a rectangular tube extending rearward from the outer peripheral edge of the front wall portion 25.

The front member 24 is assembled from front of the terminal accommodating portion 11 (housing 10). With the front member 24 assembled, the outer fitting portion 26 surrounds the terminal accommodating portion 11 to restrict forward separation of the sealing ring 23. The front wall portion 25 closes openings in the front surfaces of the accommodation chambers 15 (accommodation recesses 16). The front wall portion 25 is formed with a plurality of tab insertion openings 27 individually corresponding to the plurality of accommodation chambers 15 (accommodation recesses 16).

The terminal fitting 30 is a single component having an elongated shape in the front-rear direction as a whole and including a terminal body portion 31 in the form of a rectangular tube and a wire crimping portion 32 in the form of an open barrel. A tab of a mating terminal (not shown) passed through the tab insertion opening 27 is inserted into the terminal body portion 31. A resilient contact piece 33 capable of resiliently contacting the tab is accommodated inside the terminal body portion 31. A width of the terminal body portion 31 is slightly smaller than those of the accommodation recess 16 and the low-height portion 19. A height of the terminal body portion 31 is slightly smaller than that of the accommodation recess 16 and larger than that of the low-height portion 19.

A first locking portion 34 is formed by cutting and raising in a front end part of the upper surface of the terminal body portion 31. With the terminal fitting 30 properly accommodated in the accommodation chamber 15, the first locking portion 34 is in such a positional relationship as to be lockable to the first retaining portion 18 from front. A rear end part of an upper plate part constituting the terminal body portion 31 functions as a second locking portion 35. With the terminal fitting 30 properly accommodated in the accommodation chamber 15, the second locking portion 35 is in such a positional relationship as to be lockable to the second retaining portion 21 from front. The first locking portion 34 is hooked to the first retaining portion 18 or the second locking portion 35 is hooked to the second retaining portion 21, whereby a rearward movement of the terminal fitting 30 with respect to the housing 10 is restricted.

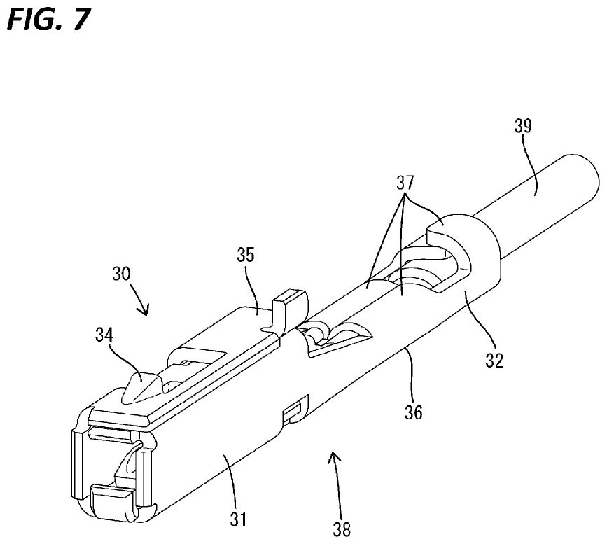

The wire crimping portion 32 is cantilevered rearward from the rear end of the terminal body portion 31. The wire crimping portion 32 includes a base plate portion 36 flush with and extending rearward from the rear end of a lower plate part constituting the terminal body portion 31 and crimping pieces 37 extending from both left and right side edges of the base plate portion 36. The wire crimping portion 32 is conductively crimped to the front end part of the wire 39 with a relative movement of the wire 39 in the front-rear direction restricted. In this way, as shown in FIG. 7, a conductive path 38 is configured in which the terminal fitting 30 and the wire 39 are integrated. The wire 39 fixed to the wire crimping portion 32 (rear end part of the terminal fitting 30) extends rearward from the terminal fitting 30.

A width of the wire crimping portion 32 crimped to the wire 39 is equal to or slightly smaller than that of the terminal body portion 31. A height of the wire crimping portion 32 crimped to the wire 39 is smaller than that of the terminal body portion 31, and the second locking portion 35 is formed due to this height difference. Further, the height of the wire crimping portion 32 crimped to the wire 39 is slightly smaller than that of the low-height portion 19. The terminal body portion 31 and the wire crimping portion 32 are in such a positional relationship as to be eccentric in the vertical direction (height direction).

In this embodiment, the larger one of the width and height of the terminal accommodating portion 11 is defined as a maximum external dimension of the terminal fitting 30. An outer diameter of the wire 39 is smaller than the maximum external dimension of the terminal fitting 30. The outer diameter of the wire 39 is equal to or slightly smaller than the width and height of the wire holding portion 20 of the housing 10. The width and height of the wire crimping portion 32 crimped to the wire 39 are larger than the width and height of the wire holding portion 20.

The one-piece rubber plug 40 is mounted into the housing 10 from behind and accommodated in the accommodation space 14. With the one-piece rubber plug 40 mounted in the housing 10, the outer periphery of the one-piece rubber plug 40 is held in close contact with the inner peripheral surface of the accommodation space 14 (tubular accommodating portion 13) in a liquid-tight manner. Further, the front end surface of the one-piece rubber plug 40 comes into contact with the rear end surface of the terminal accommodating portion 11 (back end surface of the accommodation space 14).

The one-piece rubber plug 40 is formed with a plurality of sealing holes 41 penetrating through the one-piece rubber plug 40 in the front-rear direction. The plurality of sealing holes 41 are individually arranged behind and adjacent to the rear ends (wire holding portions 20) of the plurality of accommodation chambers 15. A cross-sectional shape of the sealing hole 41 perpendicular to the front-rear direction is circular.

A minimum inner diameter of the sealing hole 41 is smaller than the maximum external dimension of the terminal fitting 30 and the outer diameter of the wire 39. The sealing hole 41 is arranged concentrically with the accommodation chamber 15 (wire holding portion 20) in the lateral direction. In the height direction, the sealing hole 41 is arranged concentrically with the narrow portion 17 (low-height portion 19 and wire holding portion 20) and arranged eccentrically downward with respect to the accommodation recess 16.

The rear member 42 is a single component including a pressing portion 43 and a pair of resilient lock pieces 44. The pressing portion 43 has the same back view shape as the accommodation space 14. The pair of resilient lock pieces 44 are cantilevered forward from both left and right end parts of the pressing portion 43. The rear member 42 is mounted in the housing 10 while being accommodated in a rear end part of the accommodation space 14 (tubular accommodating portion 13). With the rear member 42 mounted in the housing 10, the front end surface of the pressing portion 43 is in contact with the rear end surface of the one-piece rubber plug 40. In this way, the one-piece rubber plug 40 is held in an assembled state with a relative rearward displacement with respect to the housing 10 restricted. Further, the rear member 42 is held in an assembled state with the housing 10 by locking the resilient lock pieces 44 into lock holes 46 of the tubular accommodating portion 13.

The rear member 42 is formed with a plurality of wire through holes 47 penetrating through the rear member 42 in the front-rear direction. The plurality of wire through holes 47 are individually arranged behind and adjacent to the rear ends of the plurality of sealing holes 41. A cross-sectional shape of the wire through hole 47 perpendicular to the front-rear direction is circular. A minimum inner diameter of the wire through hole 47 is larger than the outer diameter of the wire 39 and the minimum inner diameter of the sealing hole 41 and smaller than the maximum external dimension of the terminal fitting 30. The wire through hole 47 is arranged concentrically with the sealing hole 41 and the narrow portion 17 (low-height portion 19 and wire holding portion 20) in the width direction (lateral direction) and the height direction (vertical direction). In the height direction, the wire through hole 47 is arranged concentrically with the accommodation recess 16 and arranged eccentrically downward with respect to the accommodation recess 16.

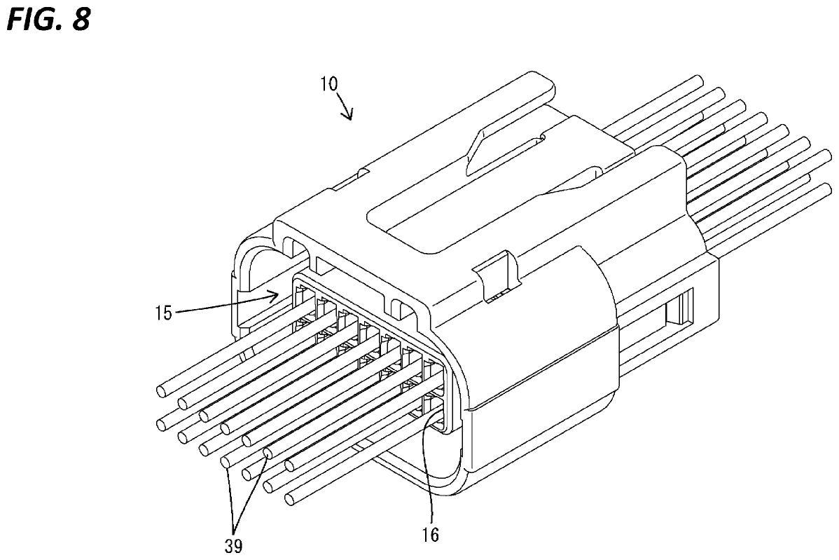

Next, a manufacturing process and an assembling process of the connector of this embodiment are described. First, the sealing ring 23, the one-piece rubber plug 40 and the rear member 42 are assembled with the housing 10 and, in that state, a plurality of the wires 39 are inserted into the wire through holes 47, the sealing holes 41 and the accommodation chambers 15 from behind the housing 10 (rear member 42) (see FIG. 8).

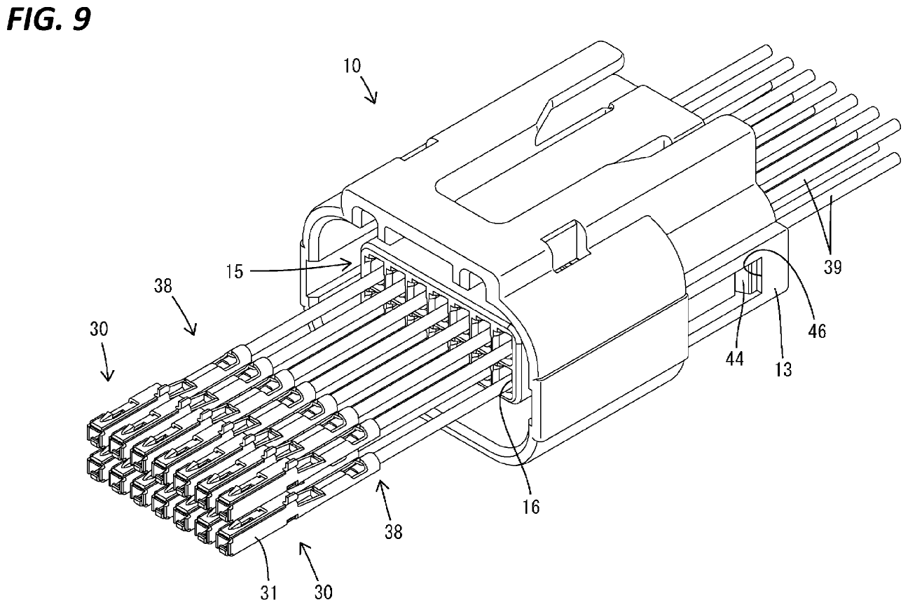

Subsequently, the wire crimping portion 32 of each terminal fitting 30 is fixed to the front end part of the wire 39 in front of the housing 10. In this way, the conductive paths 38 in which the wires 39 are passed through the housing 10 are manufactured as shown in FIG. 9. Thereafter, if a part of the wire 39 drawn out rearward of the housing 10 is pulled rearward, the conductive path 38 relatively moves rearward with respect to the housing 10 and the conductive path 38 (terminal fitting 30 and wire 39) is mounted in the housing 10.

In the process of mounting the conductive path 38 into the housing 10, the terminal fitting 30 approaches the accommodation recess 16 in front of the housing 10 as the wire 39 moves rearward in the wire through hole 47, the sealing hole 41 and the narrow portion 17. Here, since the wire through hole 47, the sealing hole 41 and the narrow portion 17 are arranged one after another concentrically in the width direction and height direction, the wire 39 moves rearward while keeping a straight state without being bent.

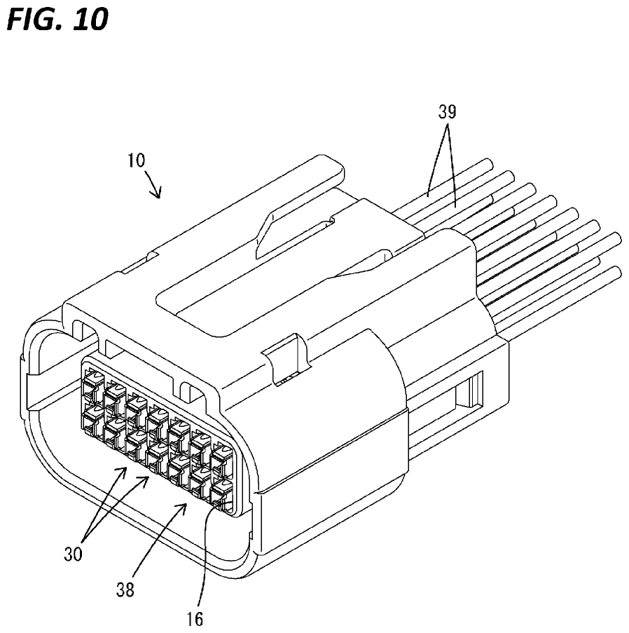

Accordingly, in the process of mounting the conductive path 38 into the housing 10, a movement course of the terminal fitting 30 in front of the housing 10 is also substantially linear. On an extension behind the movement course of the terminal fitting 30, the accommodation recess 16 is open. In this way, the terminal body portion 31 is accommodated into the accommodation recess 16 without interfering with the front end surface of the terminal accommodating portion 11 (housing 10) (see FIG. 10).

If the terminal body portion 31 is accommodated to a proper position into the accommodation recess 16, the first locking portion 34 locks the first retaining portion 18 from front and the second locking portion 35 locks the second retaining portion 21 from front, thereby restricting any further rearward movement of the terminal fitting 30.

In the above way, the mounting of the conductive paths 38 into the housing 10 is completed. With the conductive paths 38 properly mounted in the housing 10, the wire crimping portions 32 and parts of the wires 39 crimped to the wire crimping portions 32 are accommodated in the narrow portions 17 and parts of the wires 39 behind the wire crimping portions 32 are inserted in the wire holding portions 20, the sealing holes 41 and the wire through holes 47.

After the conductive paths 38 are mounted into the housing 10, the front member 24 is assembled with the housing 10 from front. With the front member 24 assembled, the front wall portion 25 closes the openings in the front ends of the accommodation recesses 16 and is in such a positional relationship as to closely face the front end surfaces of the terminal body portions 31. In this way, forward relative movements of the terminal fittings 30 with respect to the housing 10 are restricted. In the above way, the manufacturing and assembling of the connector are completed.

The connector of this embodiment includes the terminal fittings 30 connectable to the front end parts of the wires 39 and the housing 10. The accommodation chambers 15 for allowing the insertion of the terminal fittings 30 from front of the housing 10 are formed in the housing 10. The one-piece rubber plug 40 including the sealing holes 41 is mounted in the rear end part of the housing 10. The wires 39 not connected to the terminal fittings 30 can pass through the accommodation chambers 15 and the sealing holes 41.

According to this configuration, if the wire 39 is passed through the accommodation chamber 15 and the sealing hole 41, the terminal fitting 30 is connected to the front end part of the wire 39 in front of the housing 10 and the wire 39 is pulled rearward after the terminal fitting 30 is connected, the terminal fitting 30 can be accommodated into the accommodation chamber 15. Since the terminal fitting 30 needs not be passed through the sealing hole 41, the damage of the sealing hole 41 can be prevented.

Further, the terminal fitting 30 includes the terminal body portion 31 having the maximum external dimension larger than the outer diameter of the wire 39, and the accommodation chamber 15 includes the narrow portion 17 enabling the passage of the wire 39 therethrough and disabling the passage of the terminal body portion 31 therethrough. According to this configuration, even if vibration is transferred to the terminal fitting 30, the rattling of the wire 39 in the accommodation chamber 15 is suppressed by the narrow portion 17. In this way, improper deformation of the sealing hole 41 is suppressed, wherefore high sealing performance is ensured.

Further, if the narrow portion 17 is adjacent to the sealing hole 41 in such a positional relationship as to be eccentric with respect to the sealing hole 41, there is a concern that the sealing hole 41 is improperly deformed and sealing performance is reduced. However, since the narrow portion 17 communicates with the front end of the sealing hole 41 and is disposed concentrically with the sealing hole 41 in the connector of this embodiment, improper deformation of the sealing hole 41 is suppressed and high sealing performance is exhibited.

Further, the accommodation chamber 15 includes the accommodation recess 16 open in the front end surface of the housing 10. The accommodation recess 16 can accommodate the terminal body portion 31. The accommodation recess 16 is formed with the first and second retaining portions 18, 21, with which the terminal body portion 31 can come into contact from front. According to this configuration, by bringing the terminal body portion 31 into contact with the first and second retaining portions 18, 21, a rearward movement of the terminal fitting 30 can be restricted. Further, since the accommodation recess 16 communicates with the front end of the narrow portion 17 and is eccentrically disposed with respect to the narrow portion 17, a wire area of the second retaining portion 21 can be secured. In this way, an improvement of a function of retaining the terminal fitting 30 is realized.

Further, the terminal fitting 30 includes the terminal body portion 31 having the maximum external dimension larger than the outer diameter of the wire 39. The rear member 42 is provided behind the one-piece rubber plug 40. The rear member 42 includes the wire through holes 47 enabling the passage of the wires 39 therethrough and disabling the passage of the terminal body portions 31 therethrough. According to this configuration, even if the wire 39 vibrates behind the rear member 42, the rattling of the wire 39 is suppressed by the wire through hole 47. Since the deformation of the sealing hole 41 is suppressed in this way, high sealing performance is ensured.

Further, the connector of this embodiment has the following features. That is, the terminal fitting 30 includes the terminal body portion 31 connectable to the front end part of the wire 39 and having the maximum external dimension larger than the outer diameter of the wire 39. The accommodation chambers 15 are formed in the housing 30. The wire 39 can pass through the accommodation chamber 15. The accommodation chamber 15 allows the insertion of the terminal body portion 31 from front of the housing 10. The rear member 42 is mounted in the rear end part of the housing 10 and formed with the wire through holes 47. The wire 39 not connected to the terminal fitting 30 can pass through the wire through hole 47. The terminal body portion 31 cannot pass through the wire through hole 47.

According to this configuration, if the terminal fitting 30 is connected to the wire 39 passed through the accommodation chamber 15 and the wire 39 is pulled rearward in that state, the terminal body portion 31 is accommodated into the accommodation chamber 15 and the terminal fitting 30 is mounted into the housing 10. In mounting the terminal fitting 30, it is sufficient to pull the wire 39. Thus, the buckling of the wire 39 can be prevented. Further, since the wire through hole 47 has a smaller diameter than the accommodation chamber 15 where the terminal body portion 31 is to be accommodated, the rattling of the wire 39 in the accommodation chamber 15 is suppressed by being guided by the wire through hole 47. In this way, an operation of inserting the terminal fitting 30 into the accommodation chamber 15 is smoothly performed. Therefore, workability is good when the terminal fitting 30 is mounted into the housing 10.

[Other Embodiments]

The present invention is not limited to the above described and illustrated embodiment and is represented by claims. The present invention is intended to include all changes in the meaning of equivalents to claims and in the scope of claims and also include the following embodiments.

(1) Although the accommodation recess is eccentric with respect to the sealing hole in the above embodiment, the accommodation recess may be concentric with the sealing hole according to a first aspect of the invention.

(2) Although the accommodation recess is eccentric with respect to the narrow portion in the above embodiment, the accommodation recess may be concentric with the narrow portion according to the first aspect and a second aspect of the invention.

(3) Although the narrow portion and the sealing hole are concentrically arranged in the above embodiment, the narrow portion and the sealing hole may be eccentrically arranged according to the first aspect of the invention.

(4) Although the accommodation chamber includes the narrow portion disabling the passage of the terminal body portion therethrough in the above embodiment, the accommodation chamber may include no narrow portion according to the first and second aspects of the invention.

(5) Although the retaining portions are formed in the front and rear end parts of the accommodation recess in the above embodiment, a retaining portion may be formed in a central part in the front-rear direction of the accommodation recess or formed in a part other than the accommodation recess according to the first and second aspects of the invention.

(6) Although the retaining portions are formed inside the accommodation chamber in the above embodiment, retaining portion(s) may be formed outside (in front of) the accommodation chamber according to the first and second aspects of the invention.

(7) Although the maximum external dimension of the terminal fitting (terminal body portion) is larger than the outer diameter of the wire in the above embodiment, the maximum external dimension of the terminal fitting may be equal to or smaller than the outer diameter of the wire according to the first aspect of the invention.

(8) Although the terminal fitting is substantially entirely (part of the terminal fitting except a front end part) accommodated in the accommodation chamber in the above embodiment, the terminal fitting may be entirely accommodated in the accommodation chamber according to the first and second aspects of the invention.

(9) Although the terminal body portion and the wire crimping portion of the terminal fitting are eccentrically arranged in the above embodiment, the terminal body portion and the wire crimping portion may be concentrically arranged according to the first and second aspects of the invention.

(10) Although the terminal fitting is a female terminal in which the resilient contact piece is accommodated in the terminal body portion in the above embodiment, the first and second aspects of the invention can be applied also when the terminal fitting is a male terminal including a tab in a front end part.

(11) Although the wire through hole of the rear holder restricts the passage of the terminal fitting (terminal body portion) therethrough in the above embodiment, the wire through hole may be formed to allow the passage of the terminal fitting (terminal body portion) therethrough according to the first aspect of the invention.

(12) Although the wire and the terminal fitting are connected by crimping in the above embodiment, the wire and the terminal fitting may be connected by means such as welding according to the first and second aspects of the invention.

(13) Although forward withdrawal of the terminal fittings is restricted by the front member mounted in the housing in the above embodiment, the housing may be formed with resiliently displaceable resilient locking pieces and forward withdrawal of the terminal fittings may be restricted by hooking the terminal fittings to the resilient locking pieces according to the first and second aspects of the invention.

(14) Although a front stop member (front member) for restricting forward withdrawal of the terminal fittings is arranged in the front end part of the housing in the above embodiment, the front stop member may be arranged at a position behind the front end of the housing according to the first and second aspects of the invention. In this case, the front stop member may be formed with parts configured to contact front stop portions of the terminal fittings in regions behind the front ends of the terminal fittings.

### LIST OF REFERENCE NUMERALS

10 . . . housing
11 . . . terminal accommodating portion
12 . . . tubular fitting porion
13 . . . tubular accommodating portion
14 . . . accommodation space
15 . . . accommodation chamber
16 . . . accommodation recess
17 . . . narrow portion
18 . . . first retaining portion
19 . . . low-height portion
20 . . . wire holding portion
21 . . . second retaining portion
22 . . . guide surface
23 . . . sealing ring
24 . . . front member
25 . . . front wall portion
26 . . . outer fitting portion
27 . . . tab insertion opening
30 . . . terminal lilting
31 . . . terminal body portion
32 . . . wire crimping portion
33 . . . resilient contact piece
34 . . . first locking portion
35 . . . second locking portion
36 . . . base plate portion
37 . . . crimping piece
38 . . . conductive path
39 . . . wire
40 . . . one-piece rubber plug
41 . . . sealing hole
42 . . . rear member
43 . . . pressing portion
44 . . . resilient lock piece
46 . . . lock hole
47 . . . wire through hole

1. A connector, comprising:
terminal fittings to be connected to front end parts of wires;
a housing; and
a one-piece rubber plug mounted in a rear end part of the housing,
wherein:
accommodation chambers for allowing insertion of the terminal fittings from front of the housing are formed in the housing,
the one-piece rubber plug includes sealing holes,
the wires not connected to the terminal fittings are passable through the accommodation chambers and the sealing holes,
the terminal fitting includes a terminal body portion having a maximum external dimension larger than an outer diameter of the wire,
the accommodation chamber includes a narrow portion,
the wire is passable through the narrow portion,
the terminal body portion is not passable through the narrow portion, and
the narrow portion communicates with a front end of the sealing hole and is disposed concentrically with respect to the sealing hole.

2. A connector, comprising:
terminal fittings to be connected to front end parts of wires;
a housing; and
a one-piece rubber plug mounted in a rear end part of the housing,
wherein:
accommodation chambers for allowing insertion of the terminal fittings from front of the housing are formed in the housing,
the one-piece rubber plug includes sealing holes,
the wires not connected to the terminal fittings are passable through the accommodation chambers and the sealing holes,
the terminal fitting includes a terminal body portion having a maximum external dimension larger than an outer diameter of the wire,
a rear member is provided behind the one-piece rubber plug, and
the rear member includes wire through holes enabling the passage of the wires therethrough and disabling the passage of the terminal body portions therethrough.

3. A connector, comprising:
terminal fittings to be connected to front end parts of wires;
a housing; and
a one-piece rubber plug mounted in a rear end part of the housing,
wherein:
accommodation chambers for allowing insertion of the terminal fittings from front of the housing are formed in the housing,
the one-piece rubber plug includes sealing holes,
the wires not connected to the terminal fittings are passable through the accommodation chambers and the sealing holes,
the terminal fitting includes a terminal body portion having a maximum external dimension larger than an outer diameter of the wire,
the accommodation chamber includes a narrow portion,
the wire is passable through the narrow portion,
the terminal body portion is not passable through the narrow portion,
the terminal fitting includes a wire crimping portion to be crimped to the wire,
the wire crimping portion is inserted into the narrow portion,
the narrow portion includes a low-height portion, the wire crimping portion being inserted into the low-height portion, and a wire holding portion having smaller width and height than the low-height portion, and
a guide surface enlarged in diameter toward a rear side is provided in a rear end pat of the wire holding portion.

4. The connector of claim 3, wherein:
the accommodation chamber includes an accommodation recess open in a front end surface of the housing,
the accommodation recess is capable of accommodating the terminal body portion, and
the accommodation recess is formed with a retaining portion, the terminal body portion being able to come into contact with the retaining portion from front.

5. The connector of claim 4, wherein the accommodation recess communicates with a front end of the narrow portion and is disposed eccentrically with respect to the narrow portion.

6. (canceled)

7. A connector, comprising:
terminal fittings to be connected to front end parts of wires;
a housing; and
a rear member mounted in a rear end part of the housing,
wherein:
the terminal fitting includes a terminal body portion having a maximum external dimension larger than an outer diameter of the wire,
accommodation chambers for allowing insertion of the terminal fittings from front of the housing are formed in the housing, the wires being passable through the accommodation chambers,
the rear member is formed with wire through holes,
the wires not connected to the terminal fittings are passable through the wire through holes, and
the terminal body portions are not passable through the wire through holes.
